(19) United States
(12) Patent Application Publication
(10) Pub. No.: US 2009/0040399 A1
(43) Pub. Date: Feb. 12, 2009

(54) DISPLAY APPARATUS FOR DISPLAYING DIGITAL IMAGES

(76) Inventors: Chih-Hung Kao, Taipei Hsien (TW); Kuan-Chih Huang, Taipei Hsien (TW); Gary Chia-Cheng Shu, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/867,690

(22) Filed: Oct. 5, 2007

(30) Foreign Application Priority Data
Aug. 8, 2007 (TW) 096129297

(51) Int. Cl. H04N 5/64; G09G 3/30; G09G 3/36

(52) U.S. Cl. 348/840; 345/76; 345/87; 348/E05.128

(57) ABSTRACT

A display apparatus for displaying digital images includes a first housing, a second housing, a hinge, a digital image source and a plurality of display units. The hinge is coupled to the first housing and the second housing, and allows the first housing and the second housing to rotate with respect to each other. The digital image source is for supplying a plurality of digital images. The plurality of display units are positioned on the first housing and the second housing, respectively, are coupled to the digital image source, and display the plurality of digital images supplied by the digital image source.

### BACKGROUND OF THE INVENTION

1. Field of the Invention

The present invention relates to a display apparatus for displaying digital images, and more particularly, to a display apparatus having a first housing, a second housing and a hinge that allows the first housing and the second housing to rotate with respect to each other.

2. Description of the Prior Art

With progress in electronics technology, viewing digital images has become a part of everyday life in modern society. All kinds of consumer electrical products—such as televisions, computer screens, digital still cameras and cellular phones—are utilized to view digital images. In recent years, a new electrical product called a “digital album” has been developed by combining an LCD panel and a photo frame, and is intended to replace the traditional photo frame.

Existing digital image display apparatuses are placed on the table or on the wall to allow users to view their digital images. There are also handheld digital image display apparatuses. All of these digital image display apparatuses, however, only provide the simple function of viewing digital images, but cannot be used in a manner like leafing (turning) through the pages of traditional albums to view the digital images.

### SUMMARY OF THE INVENTION

It is therefore one of the objectives of the present invention to provide a display apparatus for displaying digital images to allow users to view digital images in the way of leafing (i.e., turning pages) as in traditional albums, to solve the above-mentioned problem.

According to an exemplary embodiment of the present invention, a display apparatus for displaying digital images is disclosed. The display apparatus comprises a first housing, a second housing, a hinge, a digital image source, and a plurality of display units. The hinge is coupled to the first housing and the second housing and allows the first housing and the second housing to rotate with respect to each other. The digital image source supplies a plurality of digital images. The plurality of display units are positioned on the first housing and the second housing, respectively, and coupled to the digital image source, and are for displaying the plurality of digital images supplied by the digital image source.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a display apparatus for displaying digital images according to a first embodiment of the present invention.

FIG. 2 is a diagram illustrating system structure of the display apparatus for displaying digital images according to the first embodiment of the present invention.

FIG. 3 is a diagram illustrating an exemplary way to use a display apparatus according to a first embodiment of the present invention.

FIG. 4 is a diagram illustrating another exemplary way to use a display apparatus according to a second embodiment of the present invention.

FIG. 5 is a diagram illustrating a display apparatus for displaying digital images according to a second embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

Different features of the present invention are detailed as below with reference to the figures, and for convenience of explanation, the same elements in separate figures are indicated by the same reference numerals.

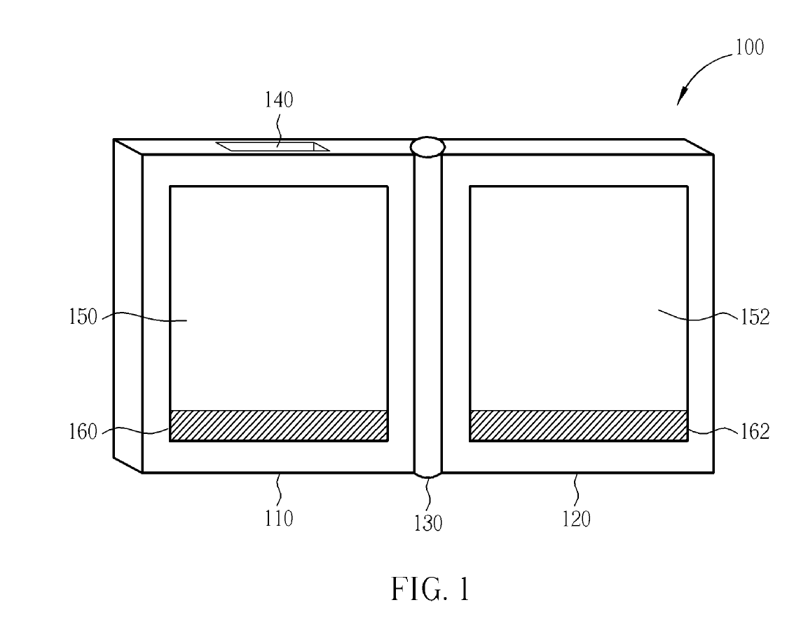

Please refer to FIG. 1. FIG. 1 is a diagram illustrating a display apparatus 100 for displaying digital images according to a first embodiment of the present invention. As shown in FIG. 1, the display apparatus 100 has a first housing 110, a second housing 120, a hinge 130, a digital image source 140 and a first display unit 150 and a second display unit 152. The hinge 130 is coupled between the first housing 110 and the second housing 120, and is used to allow the first housing 110 and the second housing 120 to rotate with respect to each other. The digital image source 140 is used to supply a plurality of digital images. The first display unit 150 is positioned on the first housing 110 and the second display unit 152 is positioned on the second housing 120. The first and second display units 150, 152 are both coupled to the digital image source 140 and are used to display the plurality of digital images supplied by the digital image source 140. In practice, the digital image source 140 can be a storage device in which digital image data is stored (e.g., a read only memory, a random access memory or a flash memory), or a transmission interface (e.g., a USB interface, a memory card interface or a network interface). Please note that the first and second display units 150, 152 are both implemented by liquid crystal display (LCD) screens in this embodiment; this is for illustrative purposes only, however, and is not meant as a limitation of the present invention. For example, the first and second display units 150, 152 can be implemented by organic light-emitting diode (OLED) display screens or other kinds of display screens.

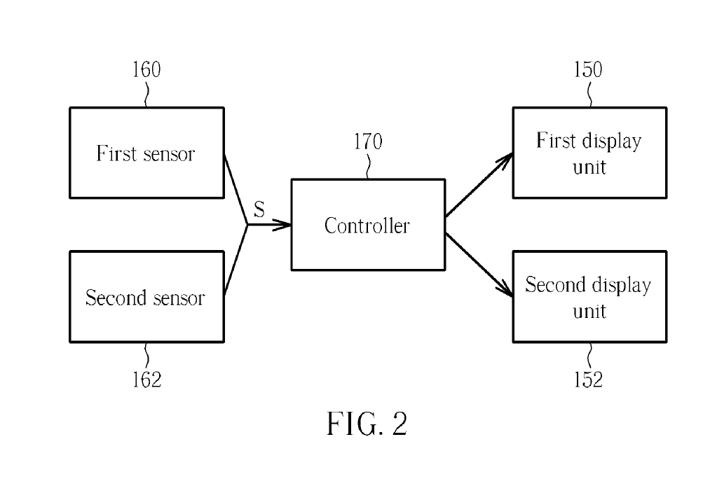

Please refer to FIG. 1 and FIG. 2 together. FIG. 2 is a diagram illustrating system structure of the display apparatus 100 for displaying digital images according to the first embodiment of the present invention. In this embodiment, the display apparatus 100 is a digital album. In order to provide the user with a way of leafing through pages as in traditional albums to view digital images, the display apparatus 100 further has a first sensor 160, a second sensor 162 and a controller 170. As shown in FIG. 1, the first sensor 160 is positioned on the first housing 110 and the second sensor 162 is positioned on the second housing 120. The first and second sensors 160, 162 are both used to detect a user input to generate a sensing signal S. On the other hand, as shown in FIG. 2, the controller 170 that is disposed inside the first housing 110 or the second housing 120 is coupled to the first and second sensors 160, 162 and the first and second display units 150, 152, and is used to control the display of the first and second display units 150, 152 according to the sensing signal S generated by the first and second sensors 160, 162. Please note that the first and second sensors 160, 162 are both touch sensors (i.e., touch panels or touch buttons) in this embodiment; this is for illustrative purposes only, however, and is not meant as a limitation of the present invention. For example, the first and second sensors 160, 162 can be implemented by non-touch sensors. Further description of the operation of the display apparatus 100 is as follows.

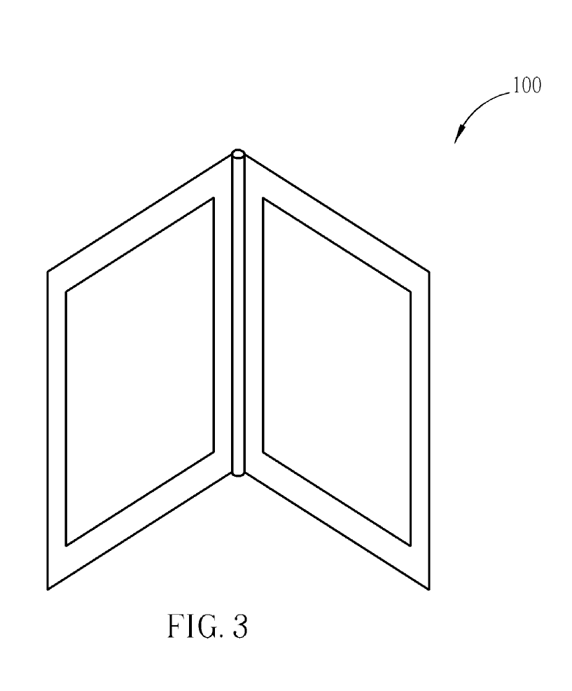

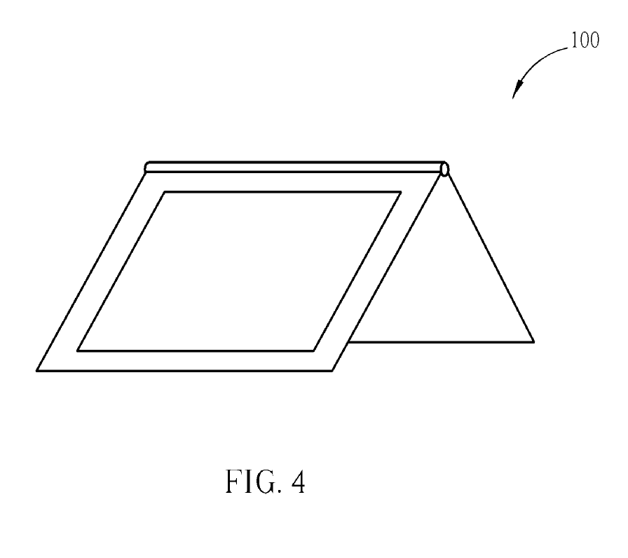

Since the hinge 130 in the display apparatus 100 allows the first housing 110 and the second housing 120 to rotate with respect to each other, the display apparatus 100 can imitate an act of opening or closing the traditional photo album when a user holds the display apparatus 100 (i.e., the digital album) to view digital images. Please refer to FIG. 3 and FIG. 4. FIG. 3 and FIG. 4 are diagrams illustrating exemplary ways to use a display apparatus according to a first and second embodiment of the present invention. The display apparatus 100 can be held to view digital images; moreover, it can be placed on the table to view digital images as well, as shown in FIG. 3 or FIG. 4.

When either of the first and second sensors 160, 162 in the display apparatus 100 detects a user input corresponding to a slide motion, the controller 170 will control the first and second display units 150, 152 to show a page turn animation to simulate viewing the traditional photo album. By way of example, when a user touches the first sensor 160 with a medium (e.g., a finger or a touch pen) and slides from left to right without leaving the first sensor 160, the first display units 150 will show a page turn animation from left to right to display the next digital image. Likely, when a user touches the second sensor 162 with the medium and slides from right to left without leaving the second sensor 162, the second display units 152 will show a page turn animation from right to left to display the next digital image. This is, however, merely for illustrative purposes, and is not meant to be a limitation of the present invention. In practice, any page turn animation that is corresponding to a user input and simulates viewing the traditional photo album also obeys the spirit of the present invention.

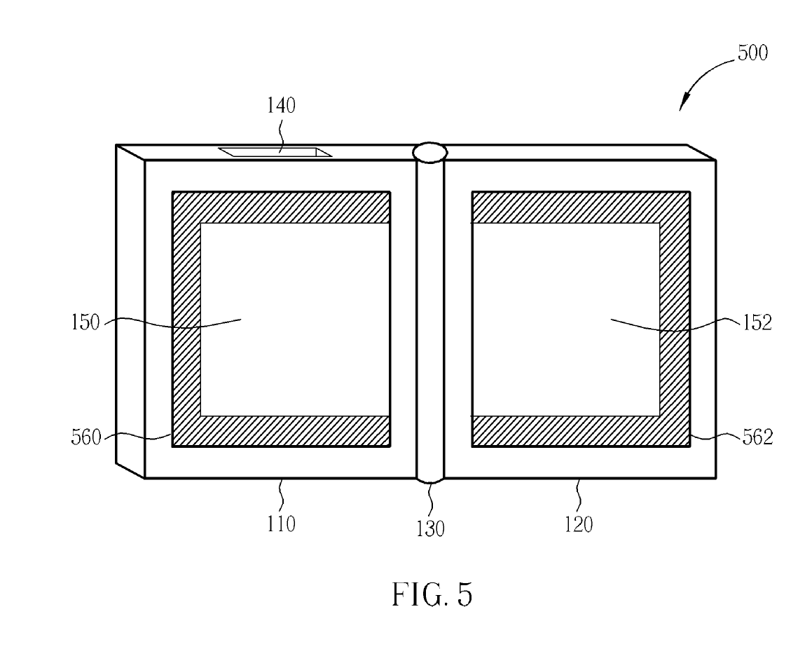

Please note that the display apparatus 100 has two sensors (i.e., the first sensor 160 and the second housing 120) in the above-mentioned embodiment; this is, however, for illustrative purposes only and is not meant as a limitation of the present invention. In other embodiments, a display apparatus can have only one sensor. Moreover, the first sensor 160 and the second sensor 162 are respectively positioned below the first display unit 150 and the second display unit 152 in the above-mentioned embodiment; again, this is for illustrative purposes only and is not meant as a limitation of the present invention. By way of example, please refer to FIG. 5. FIG. 5 is a diagram illustrating a display apparatus 500 for displaying digital images according to a second embodiment of the present invention. Because operations and functions of the elements of the display apparatus 500 shown in FIG. 5 are similar to elements with the same name in the display apparatus 100 in FIG. 1, further descriptions are not detailed here for the sake of brevity. As shown in FIG. 5, the display apparatus 500 has a first sensor 560 and a second sensor 562 which surround three sides of a first housing 510 and a second housing 520, respectively. This alternative design also falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display apparatus for displaying digital images, comprising:
a first housing;
a second housing;
a hinge, coupled to the first housing and the second housing, for allowing the first housing and the second housing to rotate with respect to each other;
a digital image source, for supplying a plurality of digital images; and
a plurality of display units, positioned on the first housing and the second housing respectively and coupled to the digital image source, for displaying the plurality of digital images supplied by the digital image source.

2. The display apparatus of claim 1, being a digital album.

3. The display apparatus of claim 1, further comprising:
a sensor, positioned on the first housing, for detecting a user input to generate a sensing signal; and
a controller, coupled to the sensor and at least one of the plurality of display units, for controlling the display of the display unit according to the sensing signal.

4. The display apparatus of claim 3, wherein the sensor is a touch sensor.

5. The display apparatus of claim 3, wherein when the sensor detects the user input corresponding to a slide motion, the controller controls the display unit to show a page turn animation.

6. The display apparatus of claim 2, wherein the plurality of display units are liquid crystal display (LCD) screens.

7. The display apparatus of claim 2, wherein the plurality of display units are organic light-emitting diode (OLED) display screens.

8. The display apparatus of claim 2, wherein the digital image source is a storage device.

9. The display apparatus of claim 2, wherein the digital image source is a transmission interface.

10. The display apparatus of claim 9, wherein the transmission is an USB interface, a memory card interface or a network interface.
